(19) United States
(12) Patent Application Publication
(10) Pub. No.: US 2026/0086311 A1
(43) Pub. Date: Mar. 26, 2026

(54) CABLE AND FIBER CASSETTE RACK MOUNT SYSTEM FOR READY DEPLOYMENT

(71) Applicant: THE LAN WIREWERKS RESEARCH LABORATORIES INC., Baie-d’Urfé (CA)

(72) Inventors: Edouard TABET, St-Phillipe (CA); Philippe SAUMURE, Dorval (CA); Simon VIGNEAULT, Rigaud (CA)

(21) Appl. No.: 19/339,848

(22) Filed: Sep. 25, 2025

Related U.S. Application Data
(60) Provisional application No. 63/698,965, filed on Sep. 25, 2024.

(51) Int. Cl. G02B 6/44

(52) U.S. Cl. CPC G02B 6/4455; G02B 6/44528; G02B 6/4457

(57) ABSTRACT

The present invention provides a cable and fiber cassette rack mount system comprising: an enclosure; a tray slidably mounted within the enclosure, the tray being movable between a storage position, a spool assembly access position and a cassette assembly access position; at least one spool assembly comprising a spool and at least one fiber optic spool cable wound around the spool, each said spool assembly being rotatably mounted on the tray adjacent to the rear opening of the enclosure; and a fiber cassette assembly comprising at least one fiber cassette and at least one fiber optic cable, the fiber cassette assembly being mounted on the tray adjacent to the front opening of the enclosure; wherein the at least one fiber optic cable is configured for connection with a corresponding fiber optic spool cable.

### FIELD OF THE INVENTION

The present invention pertains to the field of fiber optics and in particular to the management and storage of fiber optic cable.

### BACKGROUND

In the telecommunications industry, use of fiber optic cables for carrying transmission signals is rapidly growing. Fiber distribution frames are adapted to aid in the connection of fiber optic equipment. To connect fiber optic equipment in the fiber distribution frame or to connect fiber optic equipment between fiber distribution frames, fiber optic cable is routed between the fiber optic equipment and/or the fiber distribution frames.

The deployment of factory pre-terminated fiber optic cables is crucial for minimizing network downtime for cable installation. Factory pre-terminated fiber optic cables require accurate length measurements, therefore the lead time for production of the required cable must be also considered when planning the installation.

Where an extra length of cable is required, it is preferable to be able to manage the extra cable near the connection points when using factory pre-terminated fiber cables.

One prior art system for the storage and deployment of fiber optic cable is provided by CommScope (ADC) Rapid Fiber Panels and Cable Spools. The product stores up to a 200 ft of fiber cable coiled inside a panel. The maximum fiber density achieved using this system is 48F/RU. This product also manages/stores one fiber cable per panel.

Another prior art product for the storage and deployment of fiber optic cable is provided by Clearfield Smart Route Infinity Panel. This product contains two rod assemblies inside the panel around which the fiber cable is wrapped.

However, as the length of fiber optic cable needed between the fiber optic equipment and/or the fiber distribution frames varies depending on the location of the equipment in the fiber distribution frame or the location of the fiber distribution frames, there is a need for a system offering the flexibility of managing varying lengths of fiber optic cable in an effective and efficient manner.

This background information is provided to reveal information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide a cable and fiber cassette rack mount system for ready deployment. In accordance with an aspect of the present invention, there is provided a cable and fiber cassette rack mount system comprising: an enclosure comprising: a bottom panel having a front edge, a rear edge opposing the front edge, a first side edge, and a second side edge opposing the first side edge, a first side wall extending upwardly from the first side edge and having a top edge, a rear end and a front end; a second side wall extending upwardly from the second side edge and having a top edge, a rear end and a front end; and a removable top panel configured to rest upon and extend between the top edge of the first side wall and the top edge of the second side wall, wherein the front end of the first side wall, the front end of the second side wall and the front edge of the bottom panel define a front opening of the enclosure, and wherein the rear end of the first side wall, the rear end of the second side wall, the rear edge of the bottom panel, and the rear edge of the top panel define a rear opening of the enclosure; a tray slidably mounted within the enclosure, the tray being movable between a storage position, a spool assembly access position and a cassette assembly access position; at least one spool assembly comprising a spool and at least one fiber optic spool cable wound around the spool, each said spool assembly configured to be rotatably mounted on the tray adjacent to the rear opening of the enclosure; and a fiber cassette assembly comprising at least one fiber cassette and at least one fiber optic cable, the fiber cassette assembly configured to be mounted on the tray adjacent to the front opening of the enclosure; wherein the at least one fiber optic cable is configured for connection with a corresponding fiber optic spool cable.

In accordance with another aspect of the present invention, there is provided a cable and fiber cassette rack mount system comprising: an enclosure comprising: a bottom panel having a front edge, a rear edge opposing the front edge, a first side edge, and a second side edge opposing the first side edge, a first side wall extending upwardly from the first side edge and having a top edge, a rear end and a front end; a second side wall extending upwardly from the second side edge and having a top edge, a rear end and a front end; and a removable top panel configured to rest upon and extend between the top edge of the first side wall and the top edge of the second side wall, wherein the front end of the first side wall, the front end of the second side wall and the front edge of the bottom panel define a front opening of the enclosure, and wherein the rear end of the first side wall, the rear end of the second side wall, the rear edge of the bottom panel, and the rear edge of the top panel define a rear opening of the enclosure; a spool tray slidably mounted within the enclosure adjacent to the rear opening of the enclosure, the spool tray being movable between a spool assembly storage position and a spool assembly access position; at least one spool assembly comprising a spool and at least one fiber optic spool cable wound around the spool, each said spool assembly configured to be rotatably mounted on the spool tray; and a fiber cassette assembly comprising at least one fiber cassette and at least one fiber optic cable, the fiber cassette assembly configured to be slidably mounted within the enclosure adjacent to the front opening of the enclosure, the fiber cassette assembly being movable between a cassette assembly storage position and a cassette assembly access position; wherein the at least one fiber optic cable is configured for connection with a corresponding fiber optic spool cable.

### BRIEF DESCRIPTION OF THE FIGURES

FIG. 1 illustrates a perspective front view of a rack mount system, in accordance with an embodiment of the invention.

FIG. 2 illustrates a perspective rear view of the rack mount system with top panel removed and rear door opened, with the spool assembly and fiber cassette assembly in storage positions, in accordance with an embodiment of the invention.

FIG. 3 illustrates a perspective rear view of the rack mount system, in accordance with an embodiment of the invention.

FIG. 4 illustrates a perspective rear view of the rack mount system with rear door opened, in accordance with an embodiment of the invention.

FIG. 5 illustrates a perspective front view of the rack mount system with front door opened, in accordance with an embodiment of the invention.

FIG. 6 illustrates a perspective front view of the rack mount system, with fiber cassette in access position, in accordance with an embodiment of the invention.

FIG. 7 illustrates a perspective rear view of the rack mount system, with spool assembly in access position, in accordance with an embodiment of the invention.

FIG. 8 illustrates a perspective view of a fiber cassette assembly installed on a tray, in for use in a system accordance with an embodiment of the invention.

FIG. 9 illustrates a perspective rear view of the rack mount system with top panel removed and front and rear doors opened, with the spool assembly and fiber cassette assembly in storage positions, in accordance with an embodiment of the invention.

FIG. 10 illustrates a perspective view of a fiber cassette assembly installed on a tray, in for use in a system accordance with an embodiment of the invention.

FIG. 11 illustrates a perspective view of a spool assembly, for use in a system in accordance with an embodiment of the invention.

FIG. 12 illustrates a perspective front view of a rack mount system, in accordance with an embodiment of the invention.

FIG. 13 illustrates a perspective rear view of the rack mount system with top panel removed and rear door opened, with the spool assembly and fiber cassette assembly in storage positions, in accordance with an embodiment of the invention.

FIG. 14 illustrates a perspective rear view of the rack mount system, in accordance with an embodiment of the invention.

FIG. 15 illustrates a perspective rear view of the rack mount system with rear door opened, in accordance with an embodiment of the invention.

FIG. 16 illustrates a perspective front view of the rack mount system with front door opened, in accordance with an embodiment of the invention.

FIG. 17 illustrates a perspective front view of the rack mount system, with fiber cassette in access position, in accordance with an embodiment of the invention.

FIG. 18 illustrates a perspective rear view of the rack mount system, with spool assembly in access position, in accordance with an embodiment of the invention.

FIG. 19 illustrates a perspective view of a fiber cassette assembly, in for use in a system accordance with an embodiment of the invention.

FIG. 20 illustrates a perspective view of a spool assembly, for use in a system in accordance with an embodiment of the invention.

FIG. 21 illustrates a perspective rear view of the rack mount system with top panel removed and rear door opened, with the spool assembly in the access position and the fiber cassette assembly in the storage position, in accordance with an embodiment of the invention.

FIG. 22 illustrates a perspective rear view of the rack mount system with top panel removed and rear door opened, with the spool assembly in the storage position and the fiber cassette assembly in the access position, in accordance with an embodiment of the invention.

FIG. 23 illustrates a perspective rear view of the rack mount system with top panel removed and rear door opened, with the spool assembly and fiber cassette assembly in storage positions, in accordance with an embodiment of the invention.

FIG. 24 illustrates a perspective front view of the rack mount system with top panel removed and rear door opened, with the spool assembly and fiber cassette assembly in storage positions, in accordance with an embodiment of the invention.

FIG. 25 illustrates a perspective front view a fiber cassette assembly, in for use in a system accordance with an embodiment of the invention.

FIG. 26 illustrates a perspective rear view a fiber cassette assembly, in for use in a system accordance with an embodiment of the invention.

FIG. 27 illustrates a perspective rear view of the rack mount system with top panel removed and rear door opened, with the spool assembly and fiber cassette assembly in storage positions, in accordance with an embodiment of the invention.

### DETAILED DESCRIPTION OF THE INVENTION

The terms “cable”, “fiber cable” and fiber optic cable” are used interchangeably in the present specification.

The abbreviation “MPO” stands for “multi-fiber push-on” and refers to a type of optical connector employed at the end of multi-core optical fibers.

The abbreviations “LC”, “SC”and “CS”refer to types of fiber-optic connectors.

As used herein, the term “about” refers to a +/−10% variation from the nominal value. It is to be understood that such a variation is always included in a given value provided herein, whether or not it is specifically referred to.

Unless defined otherwise, all technical and scientific terms used herein have the same meaning as commonly understood by one of ordinary skill in the art to which this invention belongs.

The present invention provides a cable and fiber cassette rack mount system which allows a user to readily access both the cable spool assemblies and fiber cassette assemblies that are located within the enclosure of the system. In accordance with the present invention, the cable spool assembly and fiber cassette assembly can be slidably moved between storage and access positions.

In a first embodiment, the cable spool assembly and fiber cassette assembly are each mounted on a tray located within the enclosure, the tray being configured to slide between storage and access positions.

In accordance with a second embodiment of the present invention, both the cable spool assembly and the fiber cassette assembly can be independently moved between storage and access positions through sliding movement of the respective assemblies.

The cable and fiber cassette rack mount system of the present invention comprises an enclosure defined by a bottom panel, a removable top panel, and first and second side walls. The bottom panel has a front edge, a rear edge opposing the front edge, a first side edge, and a second side edge opposing the first side edge. The first and second side walls extend upwardly and vertically from the first and second side edges of the bottom panel, respectively. The removable top panel configured to rest upon and extend between the top edges of first and second side walls, and can be attached to the side walls through the use of attachment means such as screws or the like.

Together the respective front ends of the first and second side walls and the front edges of the bottom and top panels define a front opening of the enclosure, and the respective rear ends of the first and second side walls and the rear edges of the bottom and top panels define a rear opening of the enclosure.

In a first embodiment, the cable spool assembly and fiber cassette assembly are each mounted on a tray located within the enclosure, the tray being movable between a storage position, a spool assembly access position and a cassette assembly access position.

In a second embodiment, the cable spool assembly is mounted on a slidably mounted spool tray located within the enclosure.

In both embodiments, at least one spool assembly is rotatably mounted on the respective trays, wherein each spool assembly comprises a spool and at least one fiber optic spool cable wound around the spool. The spool cable has an inside end which terminates with one or more inside end connectors and an outside end which terminates with one or more outside end connectors.

In one embodiment, the inside end connectors and the outside end connectors are MPO connectors. The outside and inside end connectors are independently male or female connectors.

In one embodiment, the system comprises two spool assemblies mounted on the respective tray.

Being slidably mounted, the tray can be moved between a spool assembly storage position, in which the spool assembly is located within the enclosure, and a spool assembly access position, in which the spool assembly extends out through the rear opening of the enclosure.

In one embodiment, a rear door is hingedly attached at the rear opening of the enclosure and can be opened to provide access to the spool assembly located within the enclosure.

The system of the present invention further includes a fiber cassette assembly comprising at least one fiber cassette and at least one fiber optic cable.

In the first embodiment, the fiber cassette assembly is mounted on the same slidable tray as the spool assembly within the enclosure adjacent to the front opening of the enclosure. The tray is movable between a cassette assembly storage position and a cassette assembly access position. The cassette assembly can be provided with or without a bottom wall, and in the embodiment without the bottom wall, the tray serves as the bottom wall for the cassette assembly.

In the second embodiment, the fiber cassette assembly is slidably mounted within the enclosure adjacent to the front opening of the enclosure and is movable between a cassette assembly storage position and a cassette assembly access position.

In one embodiment, the fiber optic cable is a wrapped fiber optic cable which is configured to be connected with a corresponding fiber optic spool cable. In one embodiment, the end of the fiber optic cable is terminated with a mating sleeve comprising connectors configured for engagement with corresponding connectors at the inside end of the spool cable. In one embodiment, the mating sleeve is further retained in a holder element.

In one embodiment, the connectors on the fiber optic cable are MPO connectors.

In one embodiment, each fiber cassette comprises a plurality of LC, CS or SC mating sleeves. In one embodiment, each fiber cassette is provided with a plurality of simplex, duplex or quad mating sleeves. In one embodiment, each fiber cassette is configured with 3× Quad mating sleeves. In another embodiment, each fiber cassette is configured with 6× Quad mating sleeves.

In one embodiment, a front door is hingedly attached at the front opening of the enclosure and can be opened to provide access to the fiber cassette assembly located within the enclosure. In one embodiment, the front door is transparent.

The system of the present invention further includes at least one mounting bracket located on the outer surface of each of the first and second side walls.

In one embodiment, one or both of the side walls has a front cable opening located at or adjacent to the front end of each side wall, to accommodate passage of a patch cord through to allow access to the mating sleeves of the fiber cassettes.

In one embodiment, one or both of the side walls has a rear cable opening located at or adjacent to the rear end of each side wall, to accommodate passage of the spool cable out of the enclosure. In one embodiment, a cable strain relief element is provided on a corner of the spool tray adjacent to the rear cable opening.

In one embodiment, the fiber cassette assembly further comprising at least one cord management element configured to manage the location and arrangement of patch cords. The cord management elements may be located at the outer ends of the fiber cassette assembly, or at any location therebetween.

It is understood that, since the system can be installed in a horizontal or vertical orientation, the use of relative terms such as “upper” and “lower”, “upward” and “downward”, and “top” and “bottom” are used to describe orientations and locations relative to the system itself, regardless of its orientation in space.

The invention will now be described with reference to specific examples. It will be understood that the following examples are intended to describe embodiments of the invention and are not intended to limit the invention in any way.

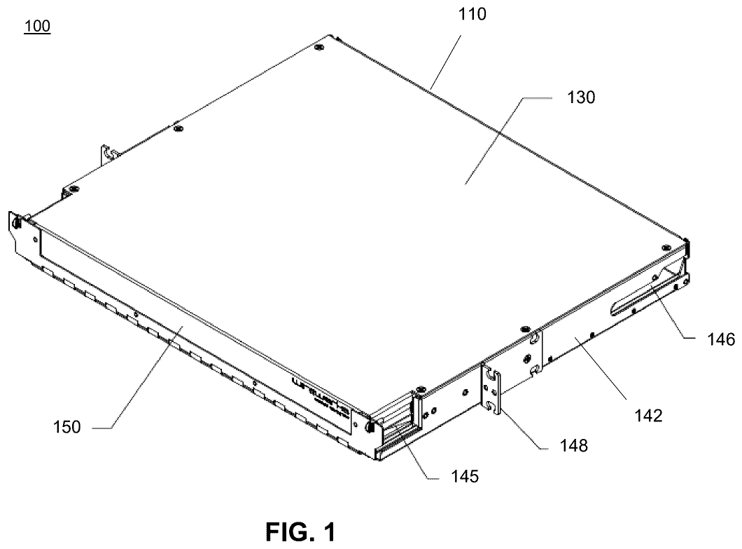

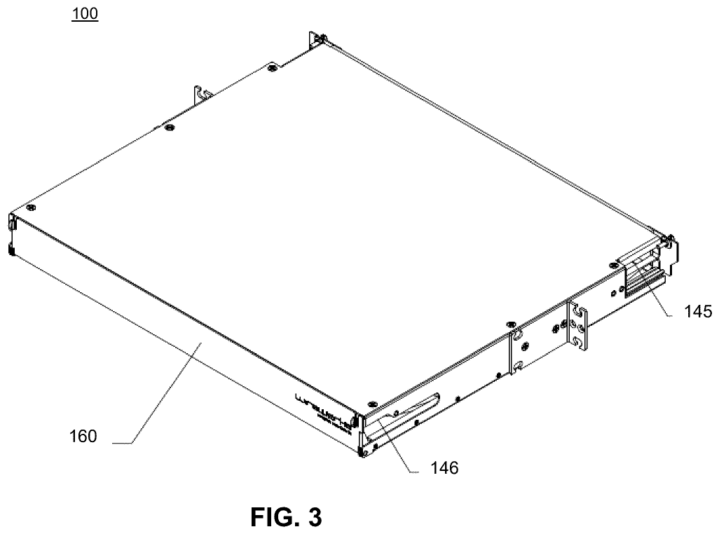

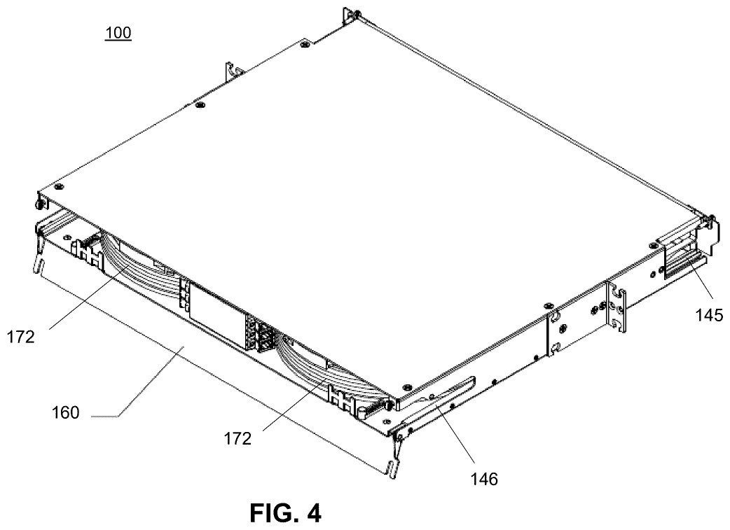

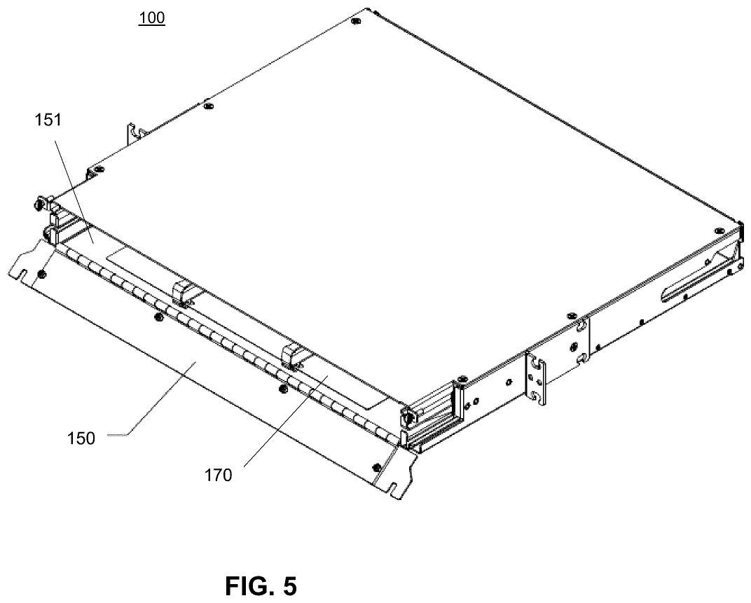

A first embodiment of the cable and fiber cassette rack mount system of the present invention is depicted in FIGS. 1 to 7. In this embodiment, cable and fiber cassette rack mount apparatus 100 comprises an enclosure 110 defined by bottom panel 120, removable top panel 130, and first and second side walls 142, 144. First side wall 142 extends upwardly from a side edge of bottom panel 120, and second side wall 144 extends upwardly from an opposing side edge of bottom panel 120.

Together the front end of the first side wall 142, the front end of the second side wall 144 and the front edge of the bottom panel 120 define a front opening 151 of the enclosure, and the rear end of the first side wall 142, the rear end of the second side wall 144, the rear edge of the bottom panel 120, and the rear edge of the top panel 130 define a rear opening 161 of the enclosure.

FIGS. 1 and 3 to 7 depict top panel 130 attached to the top edges of first side wall 142 and second side wall 144. As shown, top panel 130 is attached to the side walls through the use of screws 132.

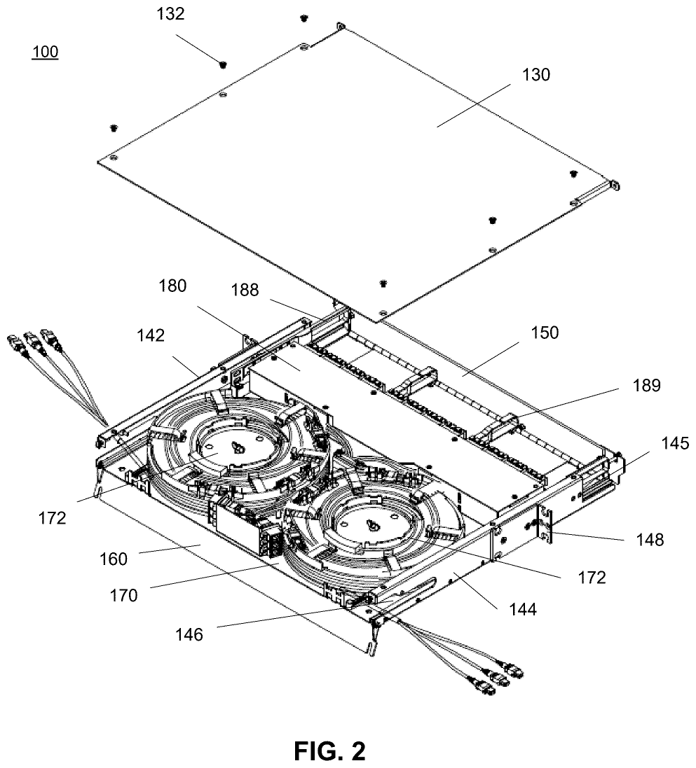

FIG. 2 depicts the system with top panel 130 removed to show interior elements located within enclosure 110, including spools 172 and fiber cassette assembly 180, which are mounted on tray 170. Tray 170 is slidably mounted within the enclosure between a storage position, a spool assembly access position and a cassette assembly access position.

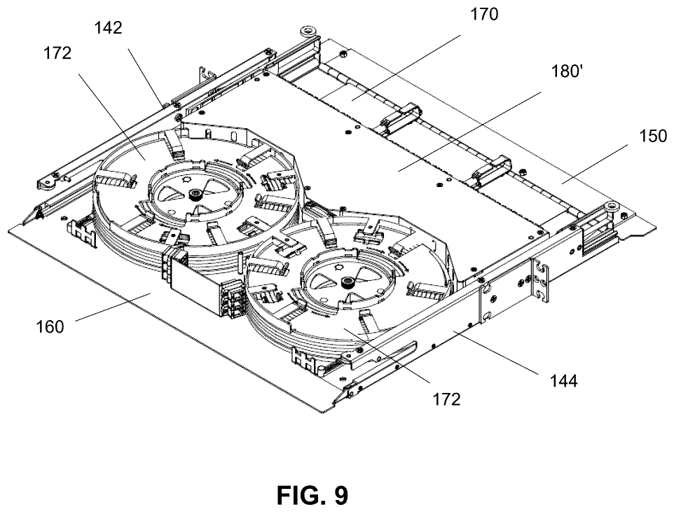

As shown in FIGS. 2, 4 and 7, two spool assemblies 171 are rotatably mounted on tray 170, wherein each spool assembly comprises spool 172 and fiber optic spool cable 174 wound around spool 172. As shown, spool cable 174 has an inside end 175 terminating with three inside end MPO connectors 176 and an outside end 177 which terminates with three outside end MPO connectors 178 after transition point 179. Spool assembly 171 is shown in isolation in FIG. 9.

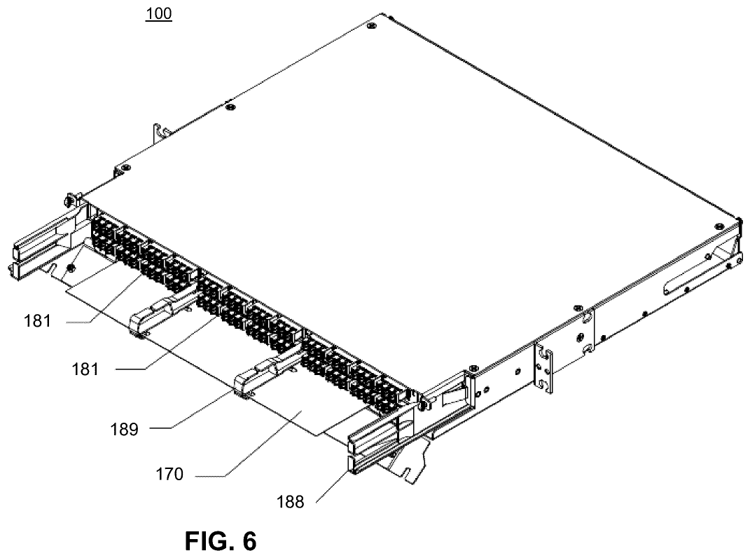

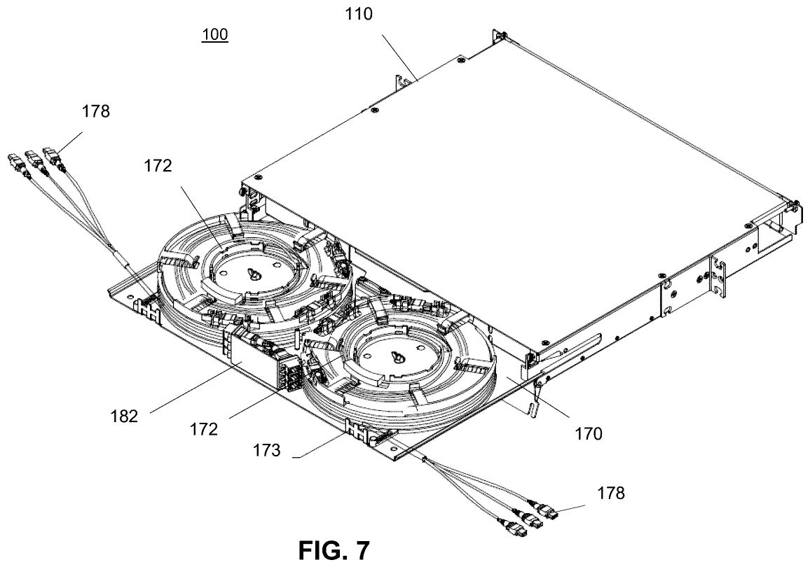

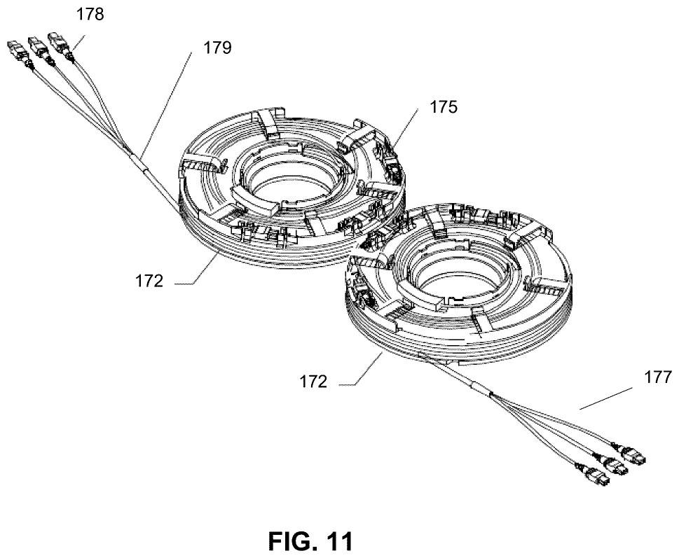

FIG. 7 shows tray 170 in a spool access position, in which spool assemblies 171 extend out through rear opening 161 of the enclosure 110. FIGS. 1, 2 to 5 and 11 show tray 170 in a storage position, in which spool assemblies 171 and fiber cassette assemblies 180 are located within enclosure 110. FIG. 6 shows tray 170 in a cassette access position, in which fiber cassette assemblies 180 extend out through front opening 151 of the enclosure 110.

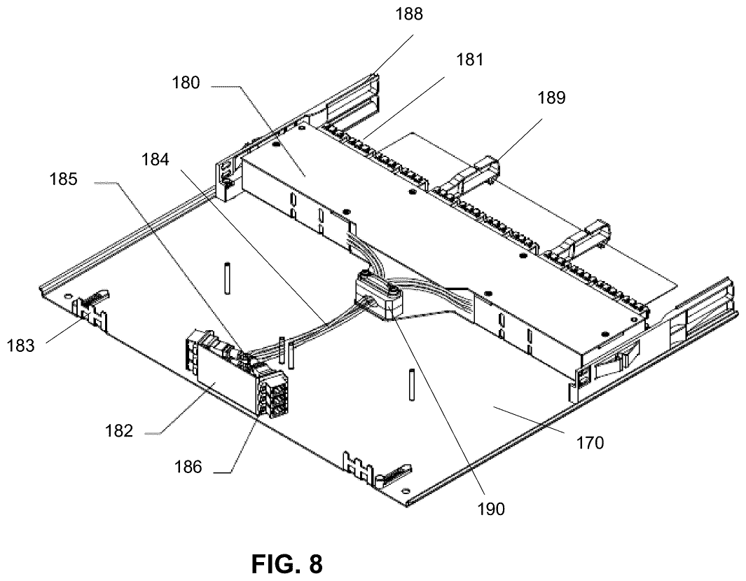

FIG. 8 depicts tray 170 with spool assemblies removed. Fiber cassette assembly 180 is mounted on tray 170. As shown, the end of the fiber optic cable 184 is terminated with mating sleeve 186 retained in holder element 182. Mating sleeve 186 comprises MPO connectors configured for engagement with corresponding MPO connectors 76 at the inside end 175 of spool cable 174 (not shown).

The enclosure shown in FIGS. 1 to 7 includes mounting bracket 148 located on the outer surface of each of the first and second side walls 142, 144. Also shown are front cable openings 145 located at the front end of each of the first and second side walls 142, 144, and rear cable openings 146 located at the rear end of each of the first and second side walls 142, 144.

As shown in FIGS. 2, 5, 6 and 8, fiber cassette assembly 180 includes fiber cassettes 181, side management elements 188 and center management elements 189.

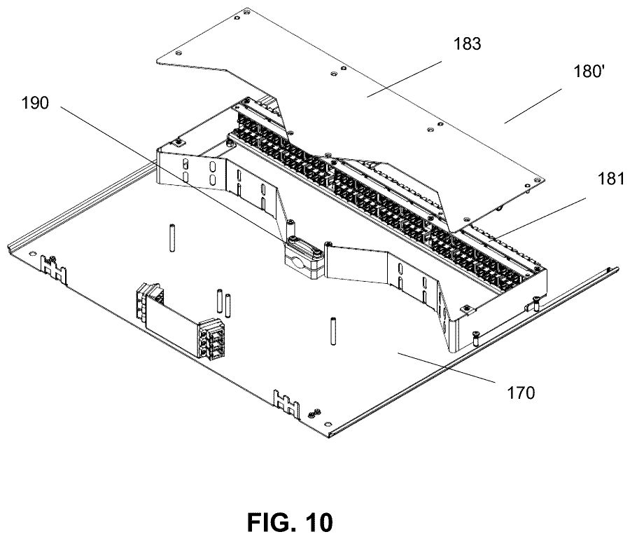

FIGS. 9 and 10 depict an alternative cassette assembly configuration, in which cassette assembly 180′does not have a bottom wall, and therefore tray 170 serves as the bottom wall for cassette assembly 180′. FIG. 10 shows cassette assembly 180′with cover 183 removed. In this embodiment, cassette assembly 180′is shaped to occupy the space not occupied by spool assemblies 172, thus providing the maximum space available for cable management within the the cassette assembly.

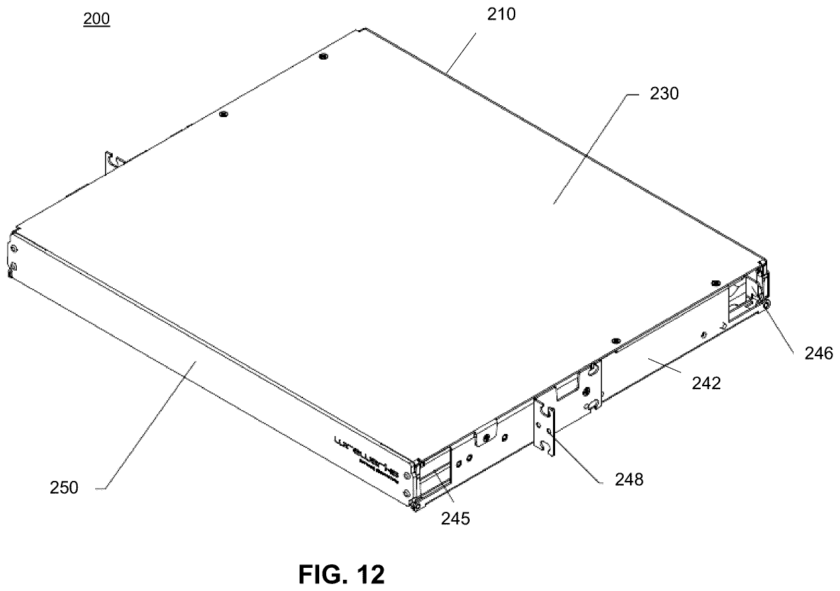

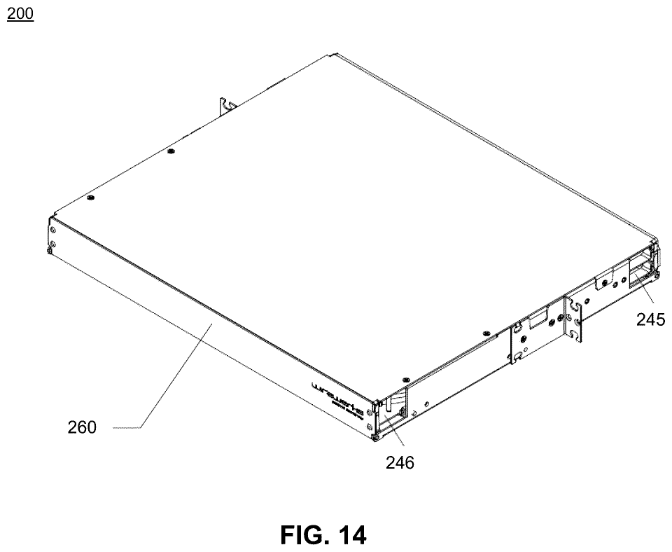

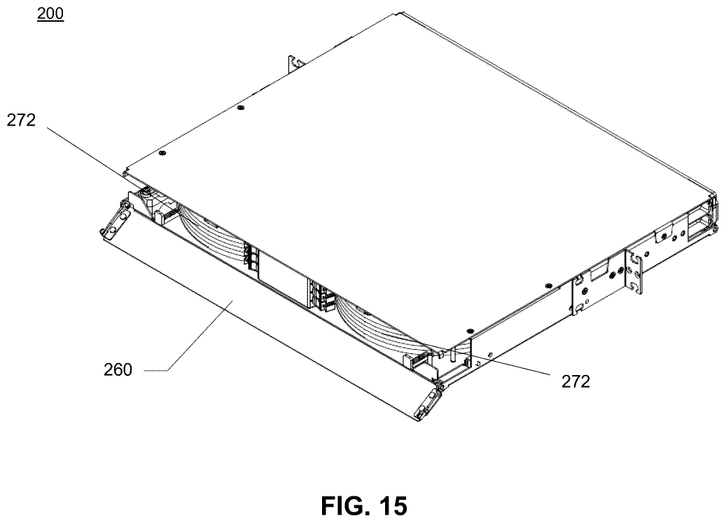

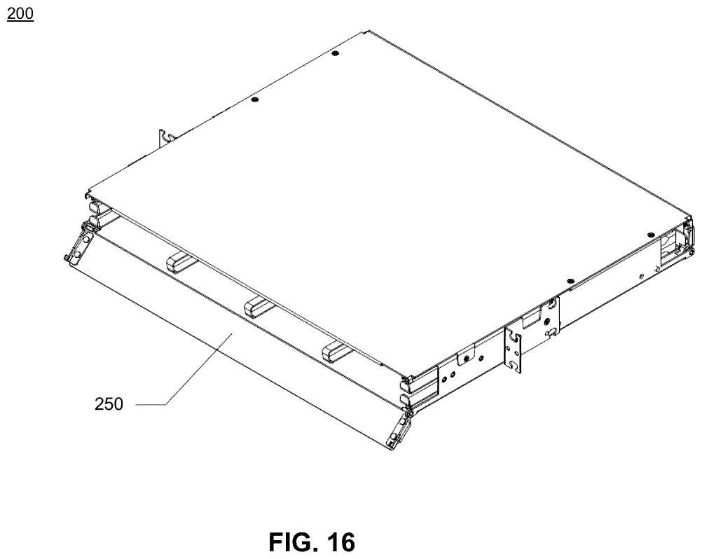

A second embodiment of the cable and fiber cassette rack mount system of the present invention is depicted in FIGS. 12 to 18, 21 and 22. In this embodiment, cable and fiber cassette rack mount apparatus 200 comprises an enclosure 210 defined by bottom panel 220, removable top panel 230, and first and second side walls 242, 244. First side wall 242 extends upwardly from a side edge of bottom panel 220, and second side wall 244 extends upwardly from an opposing side edge of bottom panel 220.

Together the front end of the first side wall 242, the front end of the second side wall 244 and the front edge of the bottom panel 220 define a front opening 251 of the enclosure, and the rear end of the first side wall 242, the rear end of the second side wall 244, the rear edge of the bottom panel 220, and the rear edge of the top panel 230 define a rear opening 261 of the enclosure.

FIGS. 12 and 14 to 21 depict top panel 230 attached to the top edges of first side wall 242 and second side wall 244. As shown, top panel 230 is attached to the side walls through the use of screws 232.

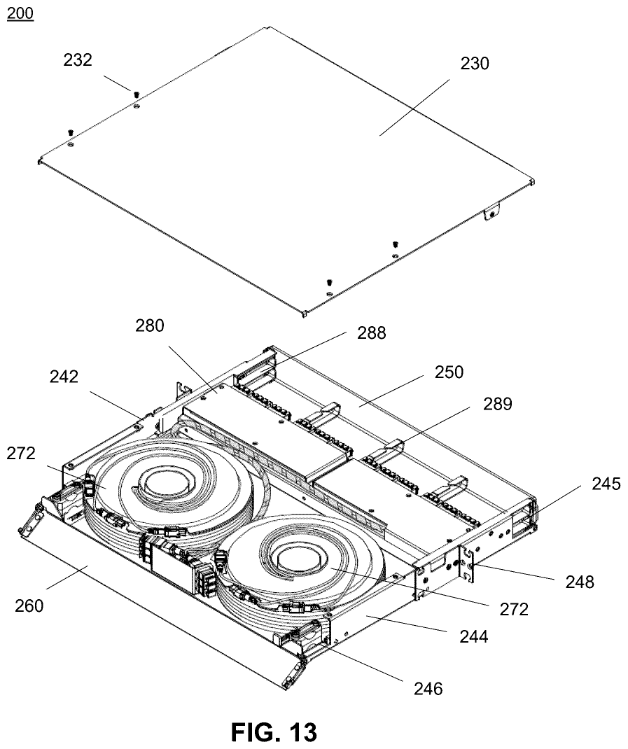

FIGS. 13, 21 and 22 depict the system with top panel 30 removed to show interior elements located within enclosure 210, including spool assembly 271, spool tray 270 and fiber cassette assembly 280.

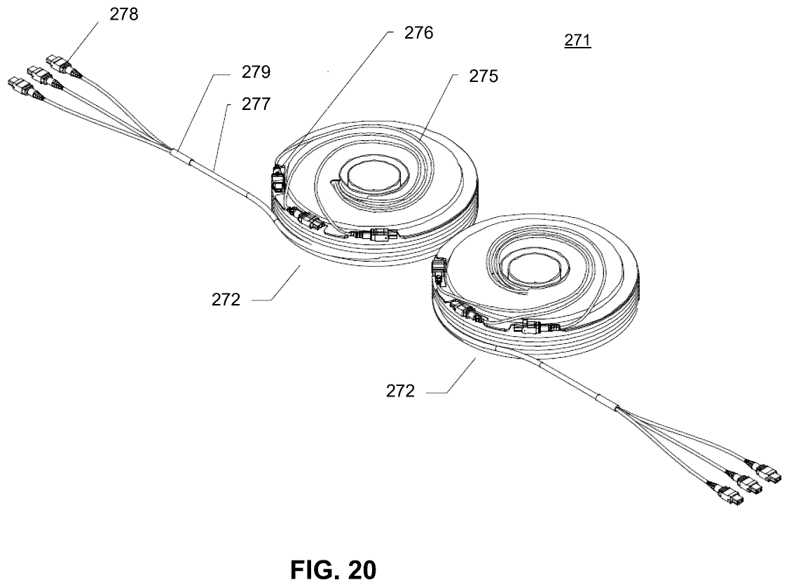

Spool tray 270 is slidably mounted within the enclosure. In the embodiment shown, two spool assemblies 271 are rotatably mounted on spool tray 270, wherein each spool assembly comprises spool 272 and fiber optic spool cable 274 wound around spool 272. As shown, spool cable 274 has an inside end 275 terminating with three inside end MPO connectors 276 and an outside end 277 which terminates with three outside end MPO connectors 278 after transition point 279. Spool assembly 271 is shown in isolation in FIG. 20.

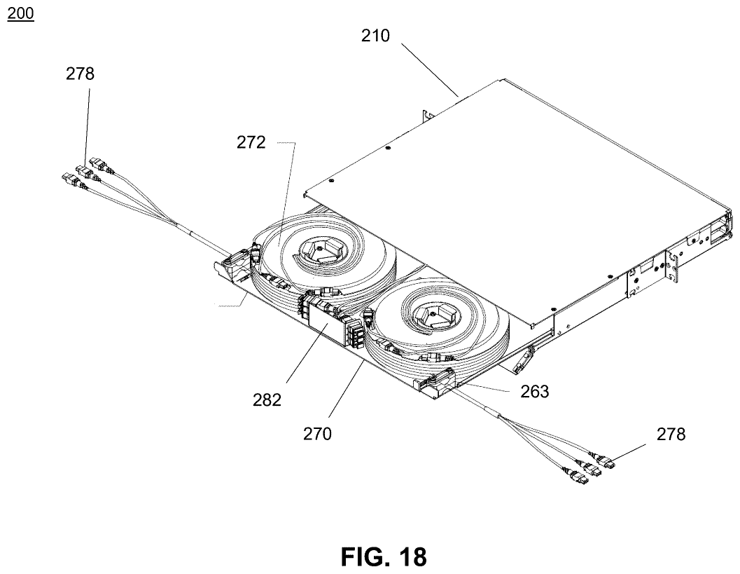

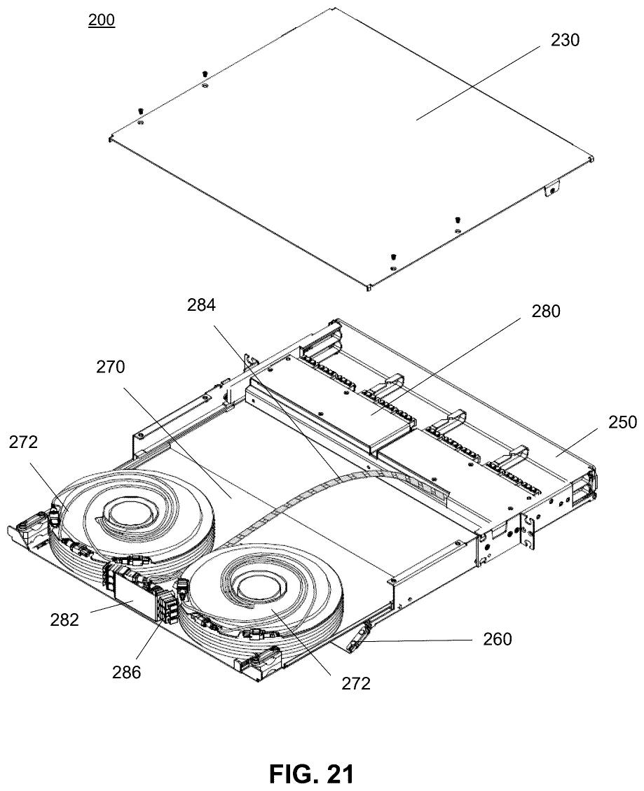

FIGS. 18 and 21 show spool tray 270 in an access position, in which spool assemblies 271 extend out through rear opening 261 of the enclosure 210. FIGS. 12 to 17 and 20 show spool tray 270 in a storage position, in which spool assemblies 271 are located within enclosure 210.

Fiber cassette assembly 280 is slidably mounted within the enclosure adjacent to front opening 251. In the embodiment shown, fiber cassette assembly 280 comprises four fiber cassettes 281 and a wrapped fiber optic cable 284 extending from the fiber cassettes.

Fiber cassette assembly 280 movable between a cassette assembly storage position and a cassette assembly access position.

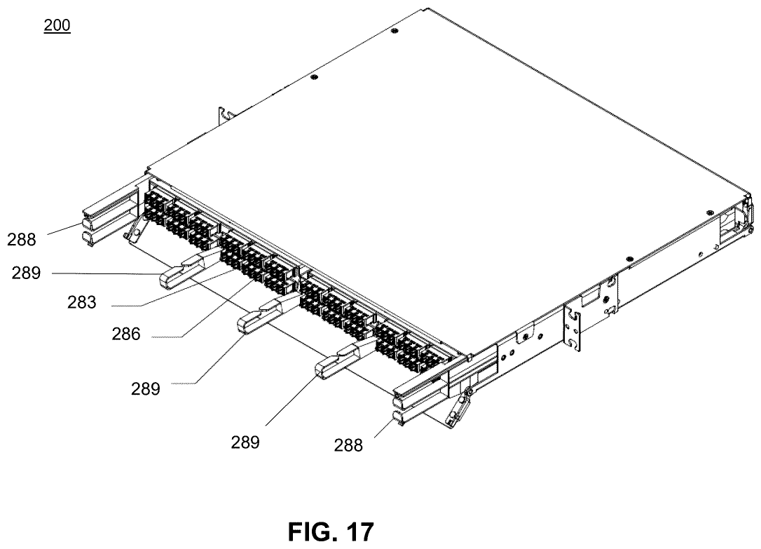

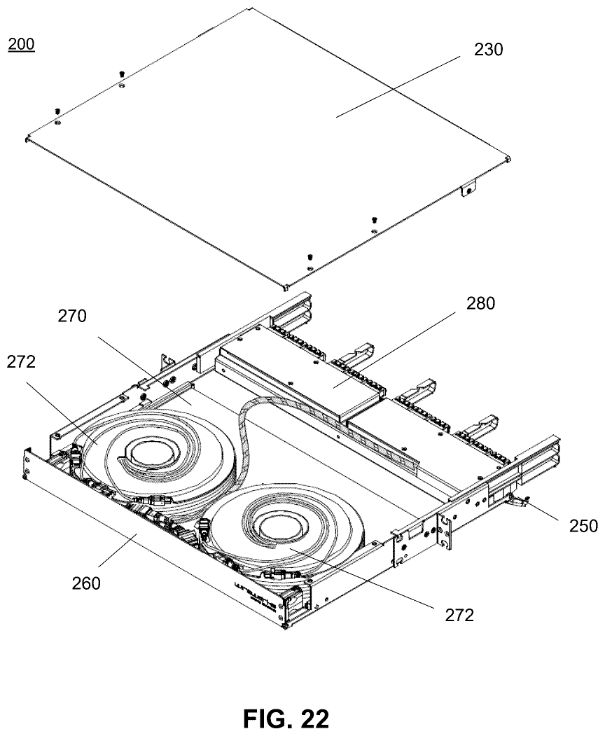

FIGS. 17 and 22 show fiber cassette assembly 280 in an access position, in which fiber cassette assembly 280 extends out through front opening 251 of the enclosure 210. FIGS. 12 to 16, 18 and 21 show fiber cassette assembly 280 in a storage position, in which fiber cassette assembly 280 is located within enclosure 210.

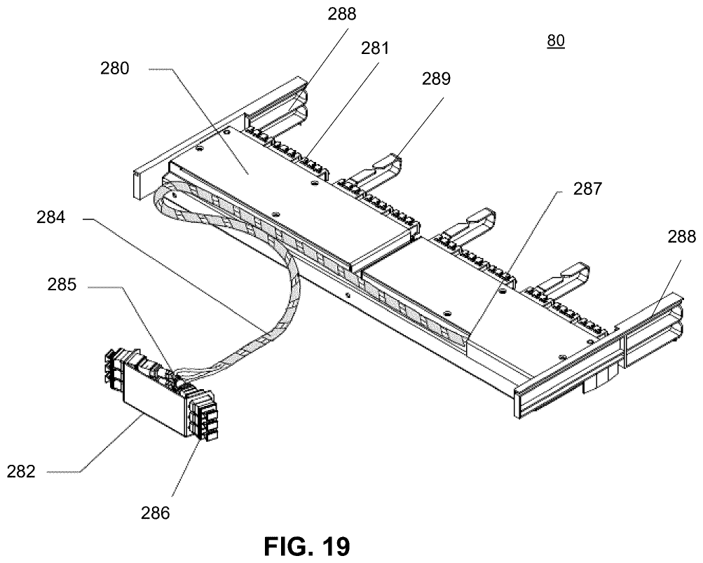

Fiber cassette assembly 280 is shown in isolation in FIG. 19. As shown, the end of the fiber optic cable 284 is terminated with mating sleeve 286 retained in holder element 282. Mating sleeve 286 comprises MPO connectors configured for engagement with corresponding MPO connectors 276 at the inside end 275 of spool cable 274.

The enclosure shown in FIGS. 12 to 18 and 20 to 22 includes mounting bracket 248 located on the outer surface of each of the first and second side walls 242, 244. Also shown are front cable openings 245 located at the front end of each of the first and second side walls 242, 244, and rear cable openings 246 located at the rear end of each of the first and second side walls 242, 244. Also shown is cable strain relief element 263 located at a corner of spool tray 270 adjacent to rear cable opening 246.

As shown in FIGS. 17 and 19, fiber cassette assembly 280 includes fiber cassettes 281, side management elements 288 and center management elements 289.

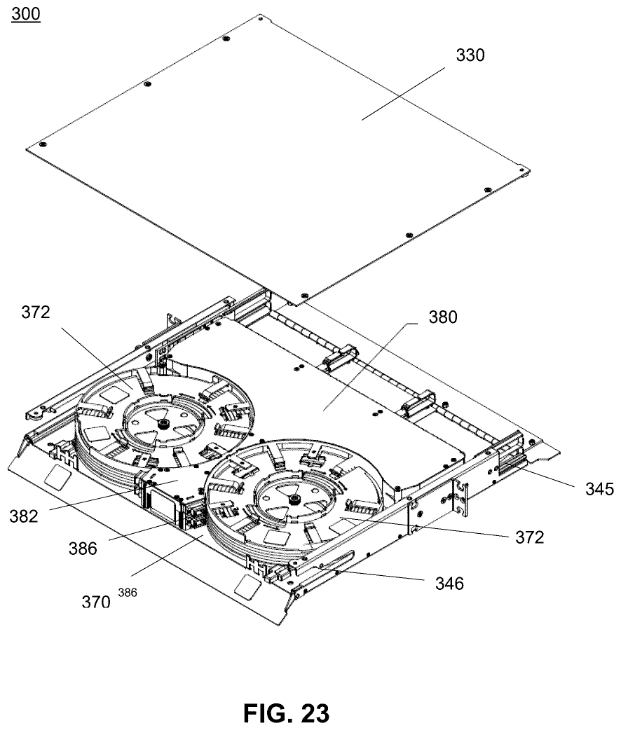

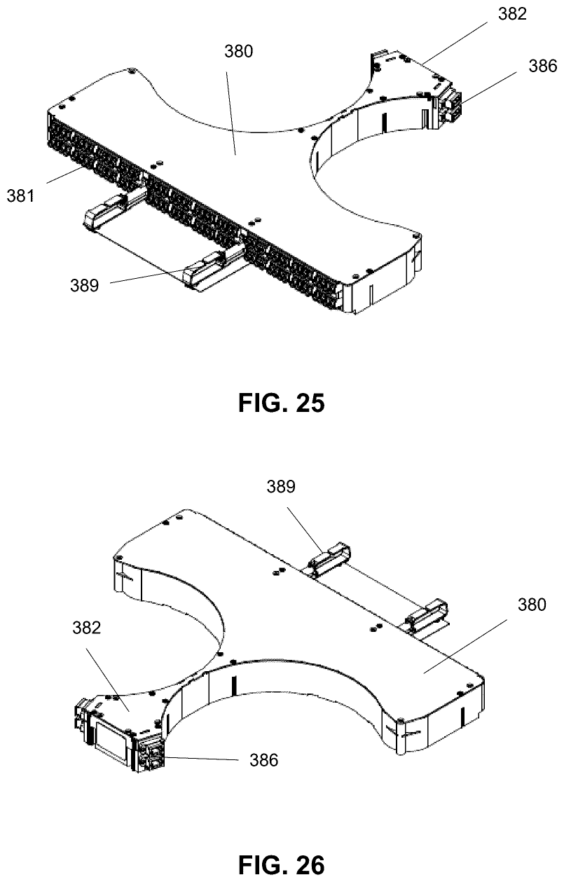

A third embodiment of the cable and fiber cassette rack mount system of the present invention is depicted in FIGS. 23 to 26. In this embodiment, cable and fiber cassette rack mount apparatus 300 comprises cassette assembly 380 which includes fibre cassettes 381 and holder element 382, including mating sleeves 386, all within a single housing. Mating sleeve 386 comprises MPO connectors configured for engagement with corresponding MPO connectors at the inside end of spool cable (not shown). Cassette assembly 380 is shaped to occupy the space not occupied by spool assemblies 372, thus providing the maximum space available for cable management within cassette assembly 380.

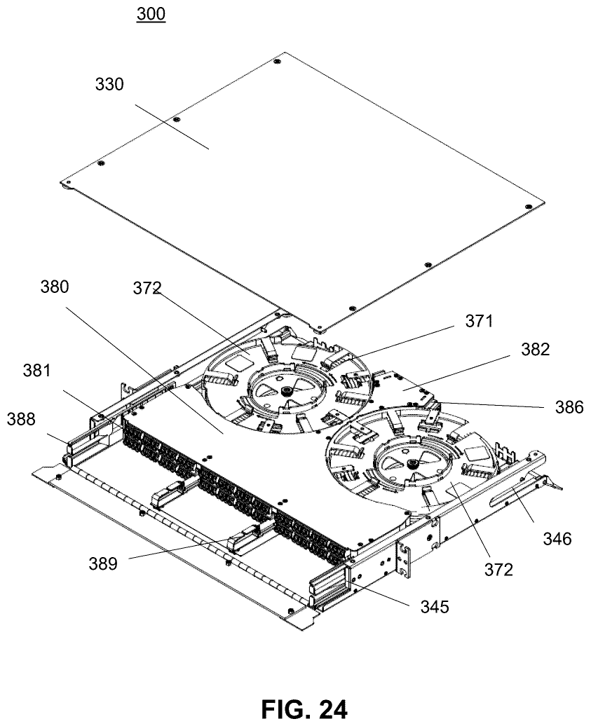

Spool tray 370 is slidably mounted within the enclosure. As shown in FIGS. 23 and 24, two spool assemblies 371 are rotatably mounted on tray 370, wherein each spool assembly comprises spool 372 and fiber optic spool cable wound around spool 372.

FIGS. 23 and 24 depict the system with top panel 330 removed to show interior elements located within enclosure, including spools 372 and fiber cassette assembly 380, which are mounted on tray 370. Tray 370 is slidably mounted within the enclosure between a storage position, a spool assembly access position and a cassette assembly access position.

The enclosure shown in FIGS. 23 and 24 includes mounting bracket 348 located on the outer surface of each of the side walls. Also shown are front cable openings 345 located at the front end of each of the side walls, and rear cable openings 346 located at the rear end of each of the side walls.

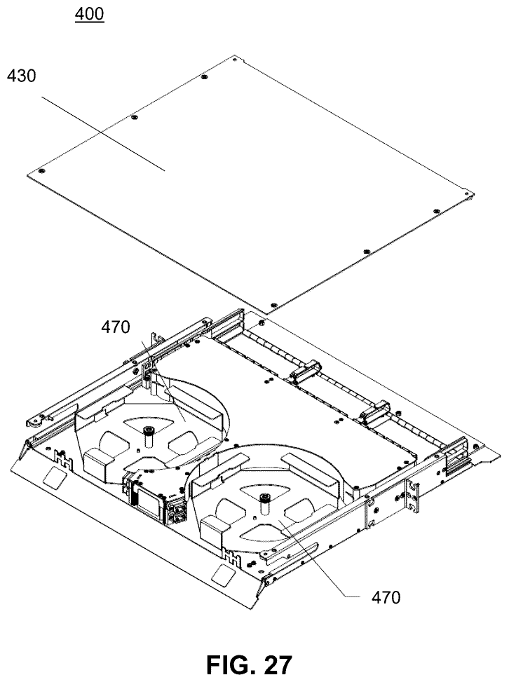

A fourth embodiment of the cable and fiber cassette rack mount system of the present invention is depicted in FIG. 27, which includes the same cassette assembly configuration as shown in FIGS. 23 to 26, but which is provided with static spools 470.

It is obvious that the foregoing embodiments of the invention are examples and can be varied in many ways. Such present or future variations are not to be regarded as a departure from the spirit and scope of the invention, and all such modifications as would be obvious to one skilled in the art are intended to be included within the scope of the following claims.

1. A cable and fiber cassette rack mount system 100 comprising:
an enclosure 110 comprising:
a bottom panel 120 having a front edge, a rear edge opposing the front edge, a first side edge, and a second side edge opposing the first side edge,
a first side wall 142 extending upwardly from the first side edge and having a top edge, a rear end and a front end;
a second side wall 144 extending upwardly from the second side edge and having a top edge, a rear end and a front end; and
a removable top panel 130 configured to rest upon and extend between the top edge of the first side wall 142 and the top edge of the second side wall 144, wherein the front end of the first side wall 142, the front end of the second side wall 144 and the front edge of the bottom panel 120 define a front opening 151 of the enclosure, and
wherein the rear end of the first side wall 142, the rear end of the second side wall 144, the rear edge of the bottom panel 120, and the rear edge of the top panel 130 define a rear opening 161 of the enclosure;
a tray 170 slidably mounted within the enclosure 110, the tray being movable between a storage position, a spool assembly access position and a cassette assembly access position;
at least one spool assembly 171 comprising a spool 172 and at least one fiber optic spool cable 174 wound around the spool 172, each said spool assembly 171 configured to be rotatably mounted on the tray 170 adjacent to the rear opening 161 of the enclosure 110; and
a fiber cassette assembly 180 comprising at least one fiber cassette 181 and at least one fiber optic cable 184, the fiber cassette assembly configured to be mounted on the tray 170 adjacent to the front opening 151 of the enclosure 110;
wherein the at least one fiber optic cable 184 is configured for connection with a corresponding fiber optic spool cable 174.

2. The system of claim 1, wherein the fiber cassette assembly further comprises a holder element 382, the holder element comprising mating sleeves 386, wherein the at least one fiber cassette and the holder element are contained within a single housing, the housing being configured to extend between the at least one spool assembly.

2. The system of claim 1, wherein the enclosure 110 further comprises a rear door 160 provided to enclose the rear opening 161 of the enclosure 110, the rear door 161 being hingedly connected.

3. The system of claim 1, wherein the enclosure 110 further comprises a front door 150 provided to enclose the front opening 151 of the enclosure 110 at least one fiber optic cable 184, the front door 150 being hingedly connected.

4. The system of claim 1, wherein the front door 150 is transparent.

5. The system of claim 1, further comprising at least one mounting bracket 148 located on an outer surface of each of the first and second side walls 142, 144.

6. The system of claim 1, wherein each of the first and second side walls 142, 144 has a front cable opening 145 located at the front end of each of the first and second side walls 142, 144.

7. The system of claim 1, wherein each of the first and second side walls 142, 144 has a rear cable opening 146 located at the rear end of each of the first and second side walls 142, 144.

8. The system of claim 1, the fiber cassette assembly further comprising at least one cord management element configured to manage the location and arrangement of patch cords.

9. The system of claim 8, wherein the at least one patch cord management element includes at least one side management element 188 and/or at least one center management element 189.

10. The system of claim 1, further comprising a cable strain relief element 163 located on a corner of the spool tray 170 adjacent to the rear cable opening 146.

11. A cable and fiber cassette rack mount system 200 comprising:
an enclosure 210 comprising:
a bottom panel 220 having a front edge, a rear edge opposing the front edge, a first side edge, and a second side edge opposing the first side edge,
a first side wall 242 extending upwardly from the first side edge and having a top edge, a rear end and a front end;
a second side wall 244 extending upwardly from the second side edge and having a top edge, a rear end and a front end; and
a removable top panel 230 configured to rest upon and extend between the top edge of the first side wall 242 and the top edge of the second side wall 244,
wherein the front end of the first side wall 242, the front end of the second side wall 244 and the front edge of the bottom panel 220 define a front opening 251 of the enclosure, and
wherein the rear end of the first side wall 242, the rear end of the second side wall 244, the rear edge of the bottom panel 220, and the rear edge of the top panel 230 define a rear opening 261 of the enclosure;
a spool tray 270 slidably mounted within the enclosure 210 adjacent to the rear opening 261 of the enclosure 210, the spool tray being movable between a spool assembly storage position and a spool assembly access position;
at least one spool assembly 271 comprising a spool 272 and at least one fiber optic spool cable 274 wound around the spool 272, each said spool assembly 271 configured to be rotatably mounted on the spool tray 270; and
a fiber cassette assembly 280 comprising at least one fiber cassette 281 and at least one fiber optic cable 284, the fiber cassette assembly configured to be slidably mounted within the enclosure adjacent to the front opening of the enclosure, the fiber cassette assembly being movable between a cassette assembly storage position and a cassette assembly access position;
wherein the at least one fiber optic cable is configured for connection with a corresponding fiber optic spool cable 274.
